(19) United States
(12) Patent Application Publication
(10) Pub. No.: US 2020/0333552 A1
(43) Pub. Date: Oct. 22, 2020

(54) LENS APPARATUS AND IMAGE PICKUP APPARATUS

(71) Applicant: CANON KABUSHIKI KAISHA, Tokyo (JP)

(72) Inventor: Kazuhiro Honobe, Saitama-shi (JP)

(21) Appl. No.: 16/845,221

(22) Filed: Apr. 10, 2020

(30) Foreign Application Priority Data
Apr. 17, 2019 (JP) 2019-078404

(51) Int. Cl. G02B 7/04; G02B 15/22

(52) U.S. Cl. CPC G02B 7/04; G02B 15/22

(57) ABSTRACT

A lens apparatus includes a first optical system movable in a direction of an optical axis to change an object distance; a second optical system arranged closer to an image side than the first optical system, and movable in the direction to adjust a position of an image plane; a first operation member configured to be operated to move the first optical system; a driving device configured to drive the second optical system; and a second operation member configured to be operated to control the driving device, at least a part of the second operation member being arranged closer to an object side in the direction than the second optical system.

### BACKGROUND OF THE INVENTION

### Field of the Invention

The present invention related to a lens apparatus and an image pickup apparatus.

### Description of the Related Art

In order to prevent out-of-focus shooting, a lens apparatus used in a broadcasting camera or the like needs to be adjusted in a so-called flange back in a state where the lens apparatus is mounted on a camera main body. There has been known a lens apparatus having a function of moving a rear-end optical system (also referred to as a rearest or final optical system or lens unit) of the lens apparatus in an optical axis direction in order to make an adjustment (compensation) for a variation in a distance between the mount face of the lens apparatus attached to the cameral main body and an image plane (flange back (length)). In addition, there has been known a lens apparatus having a function with which a rear-end optical system that is moved for a flange back adjustment is moved in the optical axis direction for the purpose of shooting a subject at a distance shorter than the minimum object distance (macrophotography). Such lens apparatuses include an operation mechanism to be operated by an operator for the flange back adjustment (image plane position adjustment) or the macrophotography. A lens apparatus disclosed in Japanese Patent Publication No. S60-46405 includes an operation member for the operation mechanism provided at an outer circumferential portion of a fixed barrel which holds the rear-end optical system.

The lens apparatus disclosed in Japanese Patent Publication No. S60-46405 may have a size increased in a radial direction due to the presence of the operation mechanism and the operation member. The operation member is located near the mount face. Near the mount face, however, there may also be a lock member with which a mount portion of the lens apparatus is fixed to a mount portion of the camera apparatus and an operation member for the lock mechanism. Having a structure in which the operation members for these two types of mechanisms are both arranged within a narrow range near the mount face, the lens apparatus may be inconvenient in terms of the operability of the operation mechanisms.

### SUMMARY OF THE INVENTION

An aspect of embodiments provides, for example, a lens apparatus beneficial in operability for image plane position adjustment and small size.

A lens apparatus, as an aspect of embodiments, includes a first optical system movable in a direction of an optical axis to change an object distance; a second optical system arranged closer to an image side than the first optical system, and movable in the direction to adjust a position of an image plane; a first operation member configured to be operated to move the first optical system; a driving device configured to drive the second optical system; and a second operation member configured to be operated to control the driving device, at least a part of the second operation member being arranged closer to an object side in the direction than the second optical system.

Further features of the present invention will become apparent from the following description of exemplary embodiments with reference to the attached drawings.

### BRIEF DESCRIPTION OF THE DRAWINGS

FIG. 1 is a longitudinal sectional view of a lens apparatus in Embodiment 1.

FIG. 2 is an exploded perspective view of a focus unit in Embodiment 1.

FIG. 3 is an exploded perspective view of a zoom unit in Embodiment 1.

FIG. 4 is an exploded perspective view of a stop unit in Embodiment 1.

FIG. 5 is an exploded perspective view of a magnification conversion unit in Embodiment 1.

FIG. 6 is an exploded perspective view of an imaging unit in Embodiment 1.

FIG. 7 is an exploded perspective view of a rear-end optical system operation member in Embodiment 1.

FIG. 8 is a top view of a magnification conversion fixed barrel in Embodiment 1

FIG. 9 is a perspective view of a flange back operation member in Embodiment 1

FIG. 10 is a top view of a macro operation member in Embodiment 1

FIG. 11A is a cross-sectional view of a rear-end optical system operation member in a state where the macro operation member is fixed in Embodiment 1.

FIG. 11B is a cross-sectional view of a rear-end optical system operation member in a state where the macro operation member is allowed to slide in Embodiment 1.

FIG. 12 is a block diagram of control information in Embodiment 1.

FIG. 13 is an exploded perspective view of a magnification conversion unit in Embodiment 2.

FIG. 14 is an exploded perspective view of a rear-end optical system operation member in Embodiment 3.

FIG. 15 is a partial cross-sectional view of a flange back operation member in Embodiment 3.

FIG. 16A is a cross-sectional view of a macro operation member in a state where a macro operation ring is fixed in Embodiment 3.

FIG. 16B is a cross-sectional view of the macro operation member in a state where the macro operation ring is allowed to slide in Embodiment 3.

### DESCRIPTION OF THE EMBODIMENTS

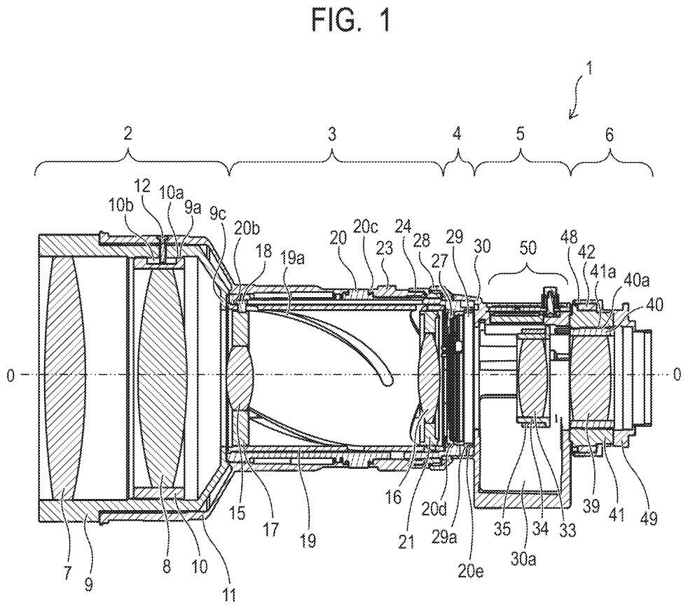

Hereinafter, preferred embodiments of the present invention are described in details based on Embodiments illustrated in FIGS. 1 to 16B.

### Embodiment 1

With reference to FIGS. 1 to 12, description is given below of a lens apparatus 1 in Embodiment 1 of the present invention. FIG. 1 is a longitudinal sectional view of the lens apparatus 1. The lens apparatus 1 includes a focus unit 2, a zoom unit 3, a stop unit 4, a magnification conversion unit 5, and an imaging unit 6.

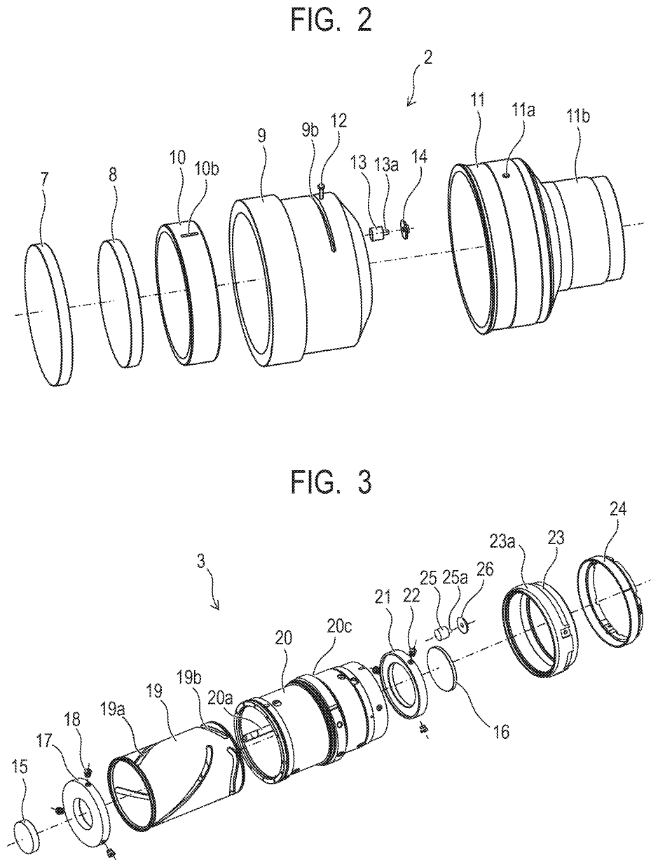

FIG. 2 is an exploded perspective view of the focus unit 2. The focus unit 2 is described with reference to FIGS. 1 and 2.

The focus unit 2 includes two optical systems called a front optical system 7 and focus optical system (first optical system) 8. The front optical system 7 is held by a focus fixed barrel 9 by using a lens holding structure such as a pressing ring or a clamp. The focus optical system 8 is held by a focus movable barrel 10 by using a lens holding structure such as a pressing ring or a clamp. A helicoid thread 10a is provided on an outer circumference of the focus movable barrel 10, and threadedly engages with a helicoid thread 9a provided at an inner circumferential portion of the focus fixed barrel 9. A focus operation ring 11 (also referred to as a focus ring) is fitted onto the focus fixed barrel 9, and rotates while sliding on the outer circumferential surface of the focus fixed barrel 9. The object distance (focusing distance) of the lens apparatus 1 is changed by moving the focus optical system 8 in an optical axis direction.

The focus operation ring (first operation member) 11 is provided with a thread portion 11a passing through the focus operation ring 11 in a direction orthogonal to an optical axis 0, and a focus linking pin 12 is fixed to the thread portion 11a. The focus linking pin 12 is in a solid pin shape, extends toward the optical axis 0 in a plane orthogonal to the optical axis 0, and is inserted in a focus fixed barrel clearance slot 9b provided in the focus fixed barrel 9 along a circumferential direction and a focus movable barrel straight groove 10b provided at an outer circumferential portion of the focus movable barrel 10 along the optical axis direction. When the focus operation ring 11 is rotated, the focus movable barrel 10 is rotated about the optical axis 0 through the focus linking pin 12, and is moved in the optical axis direction by a lead screw operation by the helicoid thread 10a and the helicoid thread 9a. As a result, the distance between the front optical system 7 and the focus optical system 8 is changed to make a focus adjustment.

An outer circumferential portion of the focus operation ring 11 is provided with a gear portion 11b that meshes with a focus ring gear 14 fitted to an input shaft 13a of a focus ring detector 13 (also referred to as a focus operation ring detector) inside a lens apparatus driving unit not illustrated. An operation amount of the focus operation ring 11 is detected by the focus ring detector 13 through the focus ring gear 14.

FIG. 3 is an exploded perspective view of the zoom unit 3. The zoom unit 3 is described with reference to FIGS. 1 and 3.

The zoom unit (third optical system) 3 includes two optical systems named a first zoom optical system 15 and a second zoom optical system 16. The first zoom optical system 15 is held by a first zoom movable barrel 17 by using a lens holding structure such as a pressing ring or a clamp. The first zoom movable barrel 17 is in a circular ring shape, and first cam followers 18 are fixed to outer circumferential portions of the first zoom movable barrel 17. Each first cam follower 18 is in a cylindrical shape, extends in a radial direction of the first zoom movable barrel 17 to be orthogonal to the optical axis 0, and is in sliding contact with a first cam slot 19a provided in a cam ring 19 and a first rectilinear groove 20a extending in the optical axis direction on a zoom fixed barrel 20.

The second zoom optical system 16 is held by a second zoom movable barrel 21 by using a lens holding structure such as a pressing ring or a clamp. The second zoom movable barrel 21 is in a circular ring shape, and second cam followers 22 are fixed to outer circumferential portions of the second zoom movable barrel 21. Each second cam follower 22 is in a cylindrical shape, extends in a radial direction of the second zoom movable barrel 21 to be orthogonal to the optical axis 0, and is in sliding contact with a second cam slot 19b in the cam ring 19 and a second rectilinear groove. The first cam followers 18, the second cam followers 22, the first cam slots 19a, the second cam slots 19b, the first rectilinear grooves 20a, and the second rectilinear grooves are arranged at three locations around the optical axis 0 at approximately equal intervals. These hold the attitudes of the first zoom movable barrel 17 and the second zoom movable barrel 21.

The cam ring 19 is in a cylindrical shape provided inside an inner circumferential portion of the zoom fixed barrel 20, is fitted to an inner circumferential surface of the zoom fixed barrel 20, and is rotatable in a sliding manner. The movement of the cam ring 19 in the optical axis direction is restricted by a fixed portion 9c provided on an image plane side (also referred to as an image side) of the focus fixed barrel 9 and a first stepped portion 20b provided on a subject side of the zoom fixed barrel 20. A zoom operation ring 23 (also referred to as a zoom ring) is fitted to the zoom fixed barrel 20 and is fitted on an outer circumferential portion of the zoom fixed barrel 20. The movement of the zoom operation ring 23 in the optical axis direction is restricted by a second stepped portion 20c of the zoom fixed barrel 20 and a zoom operation ring press 24 fixed to the zoom fixed barrel 20 with screws or the like not illustrated.

The zoom operation ring 23 is linked to the cam ring 19 with screws or the like not illustrated. When the zoom operation ring 23 is rotated, the cam ring 19 is rotated. When the cam ring 19 is rotated, the first cam followers 18 and the second cam followers 22 are moved in the optical axis direction along the first cam slots 19a, the second cam slots 19b, the first rectilinear grooves 20a, and the second rectilinear grooves. Thus, the distance between the first zoom optical system 15 and the second zoom optical system 16 is changed to change the zoom magnification. Then, an outer circumferential portion of the zoom operation ring 23 is provided with a gear portion 23a that meshes with a zoom ring gear 26 fitted to an input shaft 25a of a zoom ring detector 25 (also referred to as a zoom operation ring detector) in the lens apparatus driving unit not illustrated. The operation amount of the zoom operation ring 23 is detected by the zoom ring detector 25 through the zoom ring gear 26.

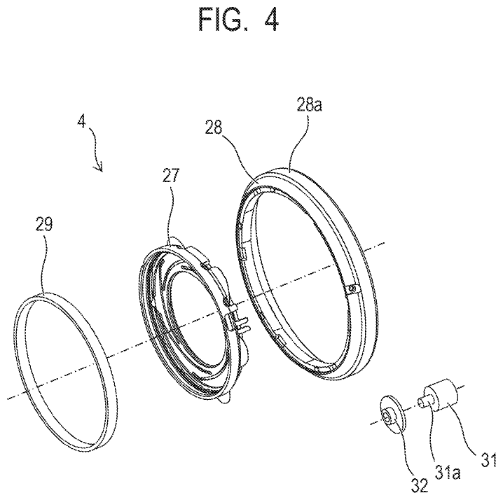

The stop unit 4 is described with reference to FIGS. 1 and 4.

The stop unit 4 (also referred to as an aperture stop unit) includes a stop mechanism 27 (also referred to as an aperture stop mechanism). The stop mechanism 27 adjusts the light amount according to an operation of a stop operation ring 28 (also referred to as a stop ring). The movement of the stop mechanism 27 in the optical axis direction is restricted by a third stepped portion 20d provided on the image plane side of the zoom fixed barrel 20 and a stop mechanism pressing ring 29 including a thread portion 29a on an outer circumferential portion of the stop mechanism pressing ring 29, and fixed with the thread portion 29a joined to a thread portion 20e provided on the image plane side of the zoom fixed barrel 20. The stop operation ring 28 is in a circular ring shape, is fitted to the zoom fixed barrel 20, and is slidable on the outer circumferential portion of the zoom fixed barrel 20. The movement of the stop operation ring 28 in the optical axis direction is restricted by the zoom operation ring press 24 fixed to the zoom fixed barrel 20 and a magnification conversion fixed barrel 30 (also referred to as a conversion optical system fixed barrel) fixed to the zoom fixed barrel 20 with screws or the like not illustrated. An outer circumferential portion of the stop operation ring 28 is provided with a gear portion 28a that meshes with a stop ring gear 32 fitted to an input shaft 31a of a stop ring detector 31 (also referred to as a stop operation ring detector) in the lens apparatus driving unit not illustrated. The operation amount of the stop operation ring 28 is detected by the stop ring detector 31 through the stop ring gear 32.

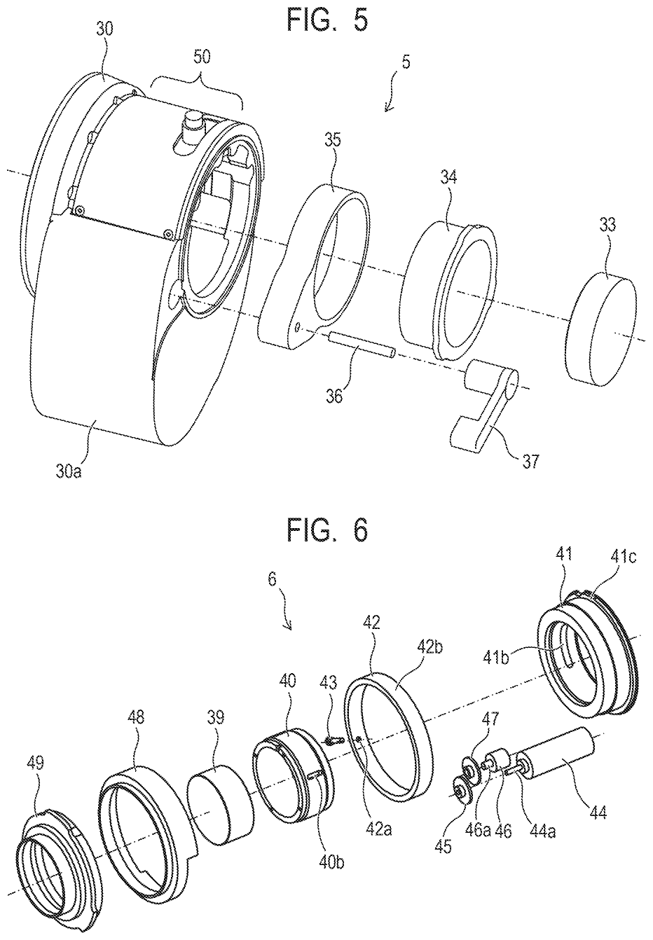

FIG. 5 is an exploded perspective view of the magnification conversion unit 5 as viewed from the image plane side. The magnification conversion unit 5 is described with reference to FIGS. 1 and 5.

The magnification conversion unit 5 includes a conversion optical system 33 (also simply referred to as a conversion optical system). The conversion optical system 33 is held by a magnification conversion lens-barrel 34 by using a lens holding structure such as a pressing ring or a clamp. The magnification conversion lens-barrel 34 is in a circular ring shape. An outer circumferential portion of the magnification conversion lens-barrel 34 is provided with a holder member 35 which is fixed to the magnification conversion lens-barrel 34 with screws or the like not illustrated. A lever shaft 36 is rotatably engaged with the holder member 35, and a switch lever 37 is fixed to the lever shaft 36. The switch lever 37 is turnable about the lever shaft 36 within a certain angle range. The switch lever 37 is fixed at two positions on both ends of the turnable angle range and the two positions are a position at which the optical axis of the conversion optical system 33 substantially coincides with the optical axis 0 and a position at which the conversion optical system 33 is retracted from an optical path (removed position). The magnification conversion fixed barrel 30 includes a housing 30a (also referred to as a housing) which receives (houses) the conversion optical system 33 when the conversion optical system 33 is retracted (removed) from the optical path. The magnification conversion fixed barrel 30 is provided with a conversion optical system detector 38 (also referred to as a conversion optical system detector) that detects whether the conversion optical system 33 is located at the position where the optical axis thereof substantially coincides with the optical axis 0 or the position where the conversion optical system 33 is retracted from the optical path. The focal length (range) of the entire lens apparatus 1 is changed (converted or shifted) by inserting and removing the magnification optical system 33 into and from the optical path.

FIG. 6 is an exploded perspective view of the imaging unit 6 as viewed from the image plane side. The imaging unit 6 is described with reference to FIGS. 1 and 6.

The imaging unit 6 includes a rear-end optical system (second optical system) 39. The rear-end optical system 39 is held by an imaging movable barrel 40 by using a lens holding structure such as a pressing ring or a clamp. An outer circumference of the imaging movable barrel 40 is provided with a helicoid thread 40a that threadedly engages with a helicoid thread 41a provided at an inner circumferential portion of an imaging fixed barrel 41. A driving ring 42 is fitted to the imaging fixed barrel 41 and rotates while sliding on the outer circumferential surface of the imaging fixed barrel 41. The driving ring 42 is provided with a thread portion 42a passing through the driving ring 42 in a direction orthogonal to the optical axis 0, and a relay linking pin 43 is fixed to the thread portion 42a. The relay linking pin 43 is a solid pin, extends toward the optical axis 0 on a plane orthogonal to the optical axis 0, and is inserted into an imaging fixed barrel clearance slot (long hole) 41b provided in the imaging fixed barrel 41 along the circumferential direction and an imaging movable barrel straight groove (long hole) 40b provided at an outer circumferential portion of the imaging movable barrel 40 along the optical axis. Thus, when the driving ring 42 is rotated, the imaging movable barrel 40 is rotated about the optical axis 0 through the relay linking pin 43, and is moved in the optical axis direction by a lead screw operation by the helicoid thread 40a and the imaging fixed barrel 41.

An outer circumferential portion of the driving ring 42 is provided with a gear portion 42b that meshes with a first gear 45 fitted to an output shaft 44a of an actuator (driving device) 44 and a second gear 47 fitted to an input shaft 46a of a driving ring detector 46. The movement of the driving ring 42 in the optical axis direction is restricted by a stepped portion 41c provided on the object side of the imaging fixed barrel 41 and a cover member 48 fixed to the imaging fixed barrel 41 with screws or the like not illustrated. A mount 49 for connection with a camera not illustrated is fixed to the image plane side of the imaging fixed barrel 41 with screws or the like not illustrated.

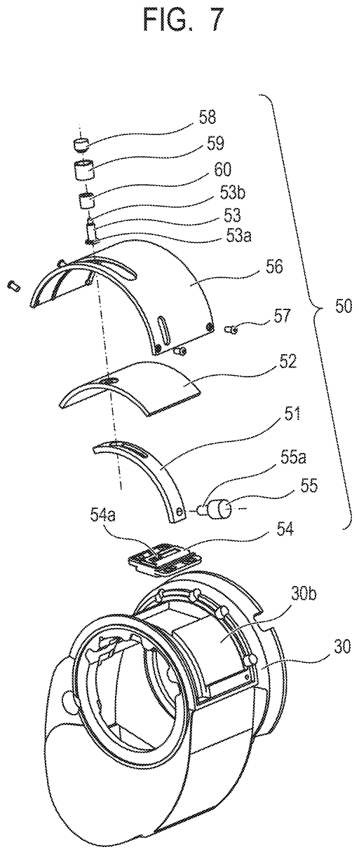

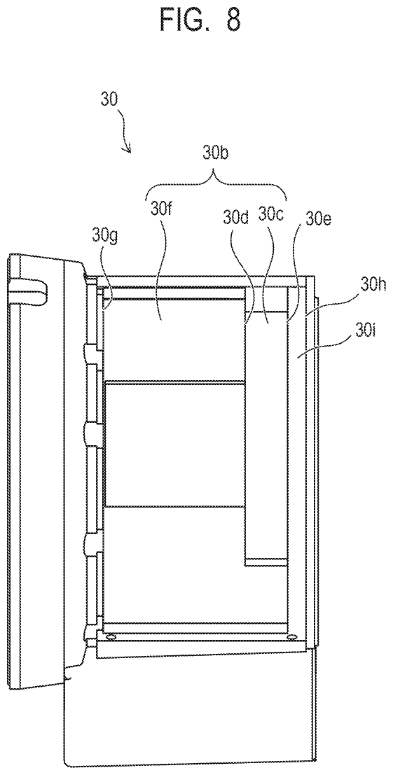

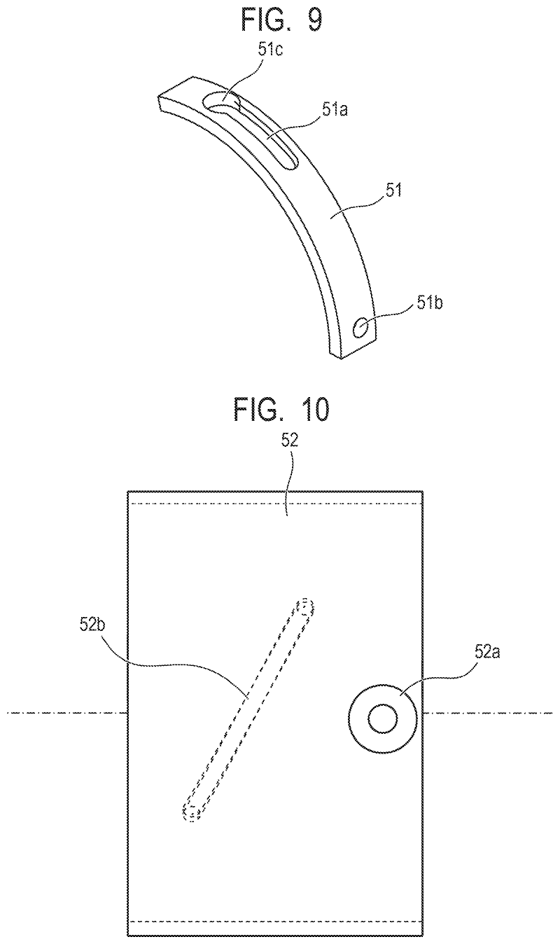

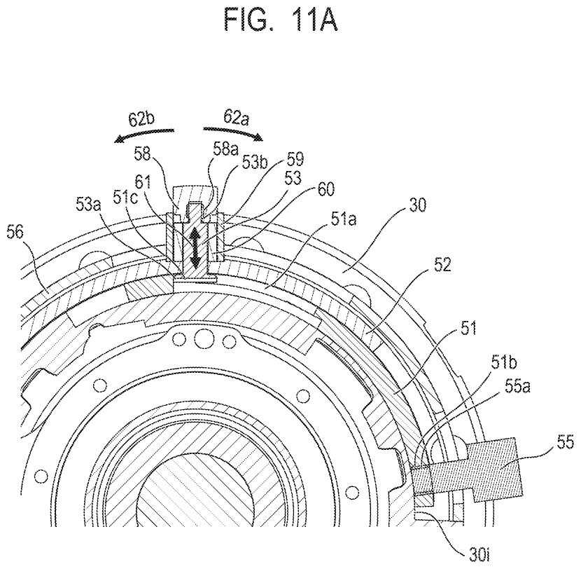

FIG. 7 is an exploded perspective view of a rear-end optical system operation member 50 as viewed from the image plane side. FIG. 8 is a top view of the magnification conversion fixed barrel 30. FIG. 9 is a perspective view of a flange back operation member 51 as viewed from the image plane side. FIG. 10 is a top view of a macro operation member 52. The rear-end optical system operation member 50 is described with reference to FIGS. 1, 7, 8, 9, and 10.

The rear-end optical system operation member (second operation member) 50 is arranged closer to an object side than the rear-end optical system 39, and is provided in an operation mechanism installation portion 30b of the magnification conversion fixed barrel 30. The rear-end optical system operation member 50 includes the flange back operation member 51, the macro operation member 52, a shaft 53, and an operation amount detector 54. The flange back operation member 51 is in a shape of an arc included in a circle having the optical axis as a center in a cross-section perpendicular or orthogonal to the optical axis, and the center is located inside the magnification conversion fixed barrel 30. The flange back operation member 51 is an operation member arranged to be capable of sliding on a flange back operation member placement portion 30c provided at an outer circumferential portion of the magnification conversion fixed barrel 30 and having an operation range in the arc shape in the cross-section perpendicular to the optical axis. The flange back operation member 51 includes a shaft clearance slot (long hole) 51a into which the shaft 53 is inserted and a thread portion 51b that threadedly engages with a thread portion 55a of a flange back knob 55. The shaft clearance slot 51a is provided along the circumferential direction, and has an arc length determined depending on an operation amount for performing macrophotography. The movement of the flange back operation member 51 in the optical axis direction is restricted by a stepped portion 30d and a stepped portion 30e provided inside the flange back operation member placement portion 30c.

The macro operation member 52 is in an arc shape, and the center of the arc is located inside the magnification conversion fixed barrel 30. The macro operation member 52 is arranged closer to the object than the rear-end optical system 39, and arranged to be capable of sliding on a macro operation member placement portion 30f provided at an outer circumferential portion of the magnification conversion fixed barrel 30. The movement of the macro operation member 52 in the optical axis direction is restricted by a stepped portion 30g and a stepped portion 30h provided inside the macro operation member placement portion 30f. The macro operation member 52 includes a through hole 52a into which the shaft 53 is inserted. The through hole 52a is fitted to the shaft 53. An inner circumferential portion of the macro operation member 52 is provided with a cam groove 52b fitted to a protrusion 54a of the operation amount detector 54. The macro operation member placement portion 30f is arranged radially outside the flange back operation member placement portion 30c. Thus, the macro operation member 52 is located radially outside the flange back operation member 51 when they are placed in the placement portions 30f and 30c.

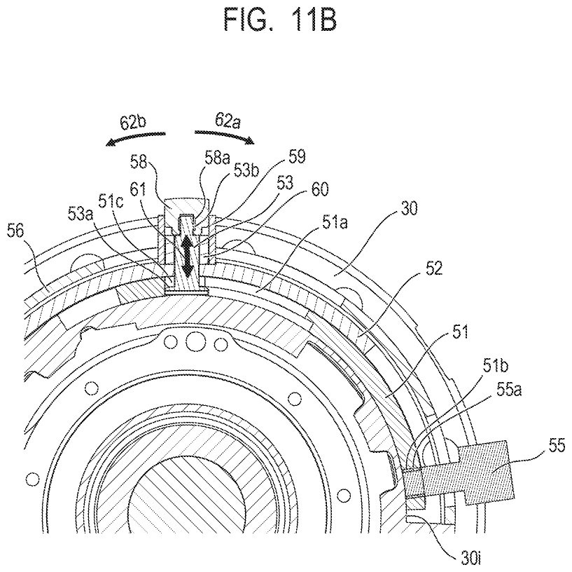

An outer circumferential portion of the macro operation member 52 is provided with an operation member fixing member 56. The operation member fixing member 56 is in an arc shape, and the center of the arc is located inside the magnification conversion fixed barrel 30. The operation member fixing member 56 is fixed to the magnification conversion fixed barrel 30 with screws 57, and restricts the movement of the flange back operation member 51 and the macro operation member 52 in the direction orthogonal to the optical axis 0. The flange back operation member 51 and the macro operation member 52 are linked to each other with the shaft 53. The shaft 53 extends toward the optical axis 0 on the plane orthogonal to the optical axis, and is inserted into the shaft clearance slot 51a and the through hole 52a. An end of the shaft 53 closest to the optical axis includes a stepped portion 53a having a diameter larger than a slot width of the shaft clearance slot 51a provided in the flange back operation member 51, and the stepped portion 53a is fitted to a shaft fixing portion 51c. The opposite end of the shaft 53 includes a thread portion 53b that threadedly engages with a thread portion 58a of a button 58 (see FIG. 11A).

FIG. 11A is a partial cross-sectional view of the rear-end optical system operation member in a state where the macro operation member is fixed. FIG. 11B is a partial cross-sectional view of the rear-end optical system operation member in a state where the macro operation member is allowed to slide. With reference to FIGS. 11A and 11B, description is given of operations for flange back adjustment and for macrophotography.

When the flange back adjustment is not performed, an end face 55b of the flange back knob 55 is pressed against an outer circumferential surface 30i of the flange back operation member placement portion 30c, thereby fixing the flange back operation member 51 and the macro operation member 52. When the flange back adjustment is performed, the flange back knob 55 is rotated to release the pressure fixing due to the contact of the end face 55b with the outer circumferential surface 30i. When the flange back knob 55 is rotated about the optical axis 0, the flange back operation member 51 is together rotated about the optical axis 0 and the macro operation member 52 is rotated about the optical axis 0 through the shaft 53. When the macro operation member 52 is rotated about the optical axis 0, the protrusion 54a is moved in the optical axis direction along the cam groove 52b. The operation amount detector 54 detects a movement amount of the protrusion 54a, and a processor (controller) 63 calculates a movement amount of the imaging movable barrel 40 and transmits driving information to the actuator 44. The actuator 44 rotates an output shaft 44a based on the driving information. When the output shaft 44a is rotated, the driving ring 42 is rotated through the first gear 45 and the rear-end optical system 39 is driven in the optical axis direction.

When the macrophotography is not performed, the stepped portion 53a is fitted to the shaft fixing portion 51c, the movement of the shaft 53 in the circumferential direction around the optical axis 0 is restricted. When the flange back operation member 51 is rotated about the optical axis 0, the shaft 53 is together rotated about the optical axis 0. When the macrophotography is performed, the button 58 is pressed down toward the optical axis 0, thereby moving the shaft 53 toward the optical axis 0 and releasing the stepped portion 53a from the fitting in the shaft fixing portion 51c, so that the shaft 53 is allowed to move along the shaft clearance slot 51a in the circumferential direction around the optical axis 0.

The shaft 53 is always biased in a biasing direction 61 by a compression spring 60 included in a shaft cover 59. In a macro ring operation, when the stepped portion 53a reaches a position at which the stepped portion 53a is to be fitted into the shaft fixing portion 51c, the stepped portion 53a is again fitted into the shaft fixing portion 51c, so that the movement of the shaft 53 in the circumferential direction around the optical axis 0 is restricted. When the shaft 53 is rotated about the optical axis 0, the macro operation member 52 in which the through hole 52a is fitted to the shaft 53 is rotated about the optical axis 0. When the macro operation member 52 is rotated about the optical axis 0, the protrusion 54a is moved along the cam groove 52b in the optical axis direction. The operation amount detector 54 detects a movement amount of the protrusion 54a. When the flange back operation member 51 and the macro operation member 52 are moved in an operation direction 62a, the rear-end optical system 39 is moved toward the object side, and the image plane is moved to get closer to the lens apparatus. When the flange back operation member 51 and the macro operation member 52 are moved in an operation direction 62b, the rear-end optical system 39 is moved toward the image plane side and the image plane is moved to get away from the lens apparatus.

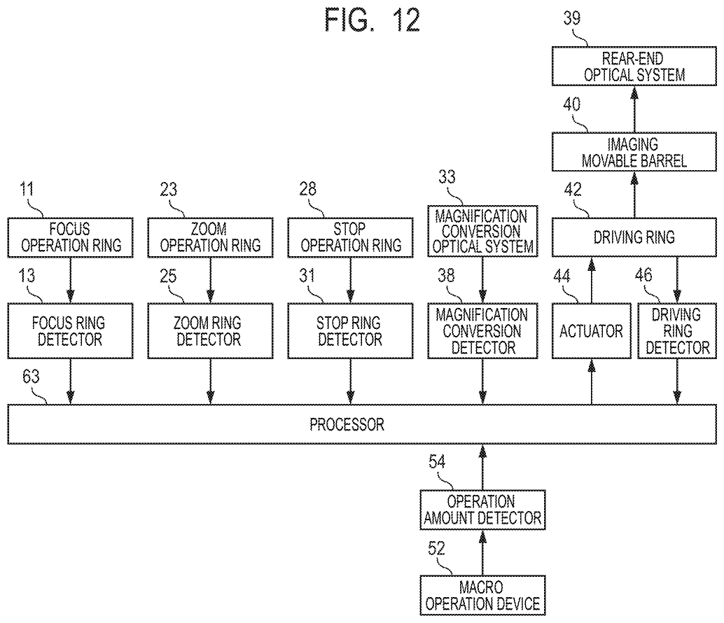

FIG. 12 is a block diagram illustrating transmission paths of control information. The transmission paths of the driving information the rear-end optical system 39 are described with reference to FIG. 12.

The description is given of a case where the flange back adjustment or the macro operation is performed. The operation amount detector 54 detects the position of the macro operation member 52 operated for the flange back adjustment or the macrophotography. Then, the driving ring detector 46 detects the position of the driving ring 42 linked to the imaging movable barrel 40 in which the rear-end optical system 39 is formed. The processor (controller) 63 acquires a detected value obtained by the operation amount detector 54 and a detected value obtained by the driving ring detector 46. The processor 63 calculates a movement amount of the rear-end optical system 39 based on the detected value obtained by the operation amount detector 54 and the detected value obtained by the driving ring detector 46, and transmits the driving information to the actuator 44.

Next, description is given of a case where the positions (states) of the focus optical system 8, the first zoom optical system 15, the second zoom optical system 16, and the conversion optical system 33 are changed. The focus ring detector 13 detects the position (state) of the focus operation ring 11. The zoom ring detector 25 detects the position (state) of the zoom operation ring 23. The stop ring detector 31 detects the position (state) of the stop operation ring 28. The conversion optical system detector 38 detects the position (state) of the conversion optical system 33. The detected value obtained by the four detectors (detecting units) are transmitted to the processor 63. Then, the driving ring detector 46 detects the position of the driving ring 42 linked to the imaging movable barrel 40 in which the rear-end optical system 39 is formed. The processor 63 calculates the movement amount of the rear-end optical system 39 based on the detected values of the detectors and transmits the driving information to the actuator 44. The actuator 44 rotates the driving ring 42 based on the driving information and the detected value of the driving ring detector 46 and drives the rear-end optical system 39 in the optical axis direction.

In the embodiment illustrated herein, described is the case where the positions of the movable optical members are indirectly detected by detecting the positions (states) of the operation rings for the movable optical members and the movement amount of the rear-end optical system 39 is calculated. However, the present invention is not limited to the above embodiment. The positions of the movable optical members may be directly detected and the movement amount of the rear-end optical system 39 may be calculated based on the detected positions.

As an effect of Embodiment 1, the structure in which the rear-end optical system operation member 50 is provided in the operation mechanism installation portion 30b arranged at the outer circumferential portion of the magnification conversion fixed barrel 30 makes it possible to make the outer diameter of the imaging unit 6 small.

In the present embodiment, the entire rear-end optical system operation member 50 is placed in the operation mechanism installation portion 30b. Instead, the rear-end optical system operation member 50 may be placed only partly in the operation mechanism installation portion 30b. For example, a placement portion may be provided at an outer circumferential portion of the imaging fixed barrel 41 in addition to the outer circumferential portion of the magnification conversion fixed barrel 30 and the rear-end optical system operation member 50 may be placed not only in the outer circumferential portion of the magnification conversion fixed barrel 30 but also in the outer circumferential portion of the imaging fixed barrel 41.

### Embodiment 2

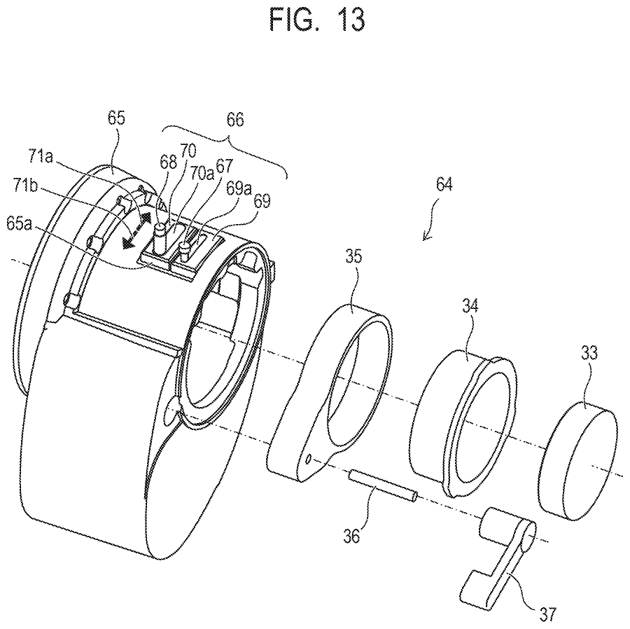

FIG. 13 is an exploded perspective view of a magnification conversion unit 64 in Embodiment 2 as viewed from the image plane side. FIG. 13 illustrates a magnification conversion fixed barrel 65 in place of the magnification conversion fixed barrel 30 in Embodiment 1 illustrated in FIG. 5 and a rear-end optical system operation member 66 in place of the rear-end optical system operation member 50 in Embodiment 1 illustrated in FIG. 7. An outer circumferential portion of the magnification conversion fixed barrel 65 is provided with a placement portion 65a, in which the rear-end optical system operation member 66 is placed. The rear-end optical system operation member 66 includes a flange back operation member 67, a flange back operation detector 69 that detects an operation amount of the flange back operation member 67, a macro operation member 68, and a macro operation detector 70 that detects an operation amount of the macro operation member 68.

When the flange back adjustment is not preformed, the flange back operation member 67 is fixed to the flange back operation detector 69 by a lock mechanism not illustrated, the flange back operation detector 69 fixed to the magnification conversion fixed barrel 65 with screws or the like not illustrated. When the flange back adjustment is performed, the flange back operation member 67 is released from locking and is operated in a direction orthogonal to the optical axis 0 along a clearance slot (long hole) 69a provided in the flange back operation detector 69. The flange back operation member 67 is an operation member arranged slidably on the placement portion 65a provided at the outer circumferential portion of the magnification conversion fixed barrel 65, and having operation directions in a plane parallel to the optical axis. In the present embodiment, in particular, illustrated is the operation member having the operation directions perpendicular to the optical axis in the plane parallel to the optical axis. The flange back operation detector 69 detects the movement amount of the flange back operation member 67, and then the processor 63 calculates the movement amount of the imaging movable barrel 40 and transmits the driving information to the actuator 44. The actuator 44 rotates the output shaft 44a based on the driving information. When the output shaft 44a is rotated, the driving ring 42 is rotated through the first gear 45 and the rear-end optical system 39 is driven in the optical axis direction.

When the macrophotography is not performed, the macro operation member 68 is fixed to the macro operation detector 70 by a lock mechanism not illustrated, the macro operation detector 70 fixed to the magnification conversion fixed barrel 65 with screws or the like not illustrated. When the macrophotography is performed, the macro operation member 68 is released from locking and is operated in a direction orthogonal to the optical axis 0 along a clearance slot (long hole) 70a provided in the macro operation detector 70. The macro operation detector 70 detects the movement amount of the macro operation member 68, and then the processor 63 calculates the movement amount of the imaging movable barrel 40 and transmits the driving information to the actuator 44. The actuator 44 rotates the output shaft 44a based on the driving information. When the output shaft 44a is rotated, the driving ring 42 is rotated through the first gear 45 and the rear-end optical system 39 is driven in the optical axis direction. When the flange back operation member 67 and the macro operation member 68 are moved in an operation direction 71a, the rear-end optical system 39 is moved toward the object side. When the flange back operation member 67 and the macro operation member 68 are moved in an operation direction 71b, the rear-end optical system 39 is moved toward the image plane side.

As an effect of Embodiment 2, the structure in which the rear-end optical system operation member 66 is provided in the placement portion 65a arranged at the outer circumferential portion of the magnification conversion fixed barrel 65 makes it possible to make the outer diameter of the imaging unit 6 small.

In the present embodiment, the entire rear-end optical system operation member 66 is placed in the placement portion 65a. Instead, the rear-end optical system operation member 66 may be placed only partly in the placement portion 65a. For example, a placement portion may be provided at an outer circumferential portion of the imaging fixed barrel 41 in addition to the outer circumferential portion of the magnification conversion fixed barrel 65 and the rear-end optical system operation member 66 may be placed not only in the outer circumferential portion of the magnification conversion fixed barrel 65 but also in the outer circumferential portion of the imaging fixed barrel 41.

### Embodiment 3

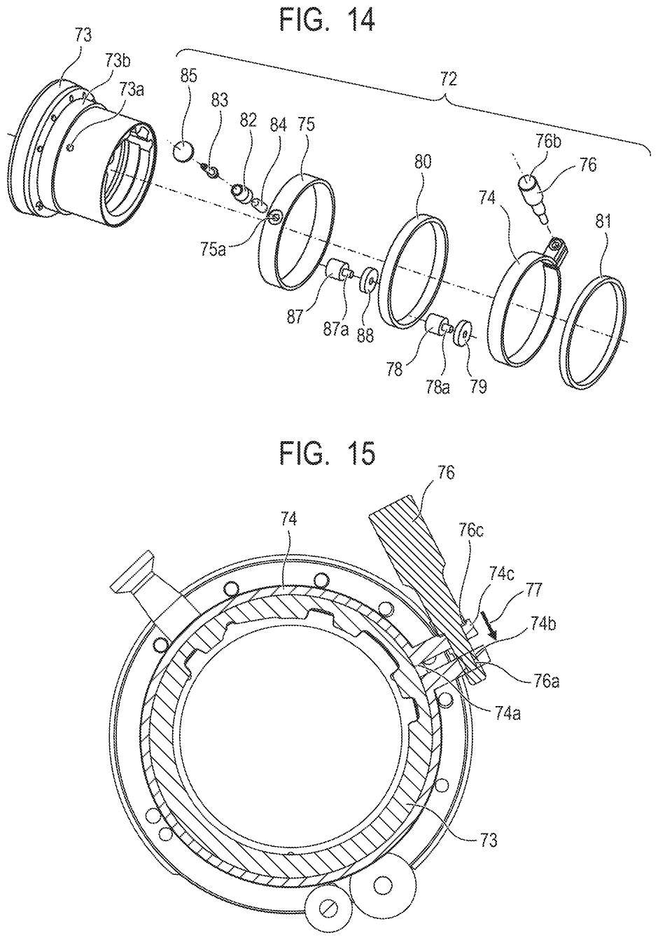

FIG. 14 is an exploded perspective view of a rear-end optical system operation member 72 in Embodiment 3 as viewed from the image plane side. FIG. 14 illustrates a fixed barrel 73 in place of the magnification conversion fixed barrel 30 in Embodiment 1 illustrated in FIG. 5 and the rear-end optical system operation member 72 in place of the rear-end optical system operation member 50 in Embodiment 1 illustrated in FIG. 7. Unlike Embodiment 1, Embodiment 3 does not include the conversion optical system 33. The fixed barrel 73 is in a circular ring shape and is fixed to the imaging fixed barrel 41 with screws or the like not illustrated. The rear-end optical system operation member 72 includes a flange back operation ring 74, a macro operation ring 75, a flange back knob 76, and a macro knob 85. The flange back operation ring 74 to be used for flange back adjustment and the macro operation ring 75 to be used for macrophotography are provided in an outer circumferential portion of the fixed barrel 73. FIG. 15 is a partial cross-sectional view of a flange back operation member as viewed from the image plane side.

With reference to FIG. 15, description is given of an operation for flange back adjustment.

The flange back operation ring 74 is in a circular ring shape (a circular shape in a cross-section perpendicular to the optical axis) and is slidable on the outer circumferential surface of the fixed barrel 73. The flange back operation ring 74 includes a cutout portion 74a and a thread portion 74b that threadedly engages with a thread portion 76a of the flange back knob 76. When the flange back knob 76 is rotated about a shaft 76b, an end portion 74c of the flange back operation ring 74 is pressed in a direction 77 by a stepped portion 76c included in the flange back knob 76, so that the width of the cutout portion 74a is narrowed. This increases friction between the flange back operation ring 74 and the fixed barrel 73, so that the flange back operation ring 74 is fixed to the fixed barrel 73.

When the flange back adjustment is not performed, the flange back knob 76 is rotated about the shaft 76b to fix the flange back operation ring 74 to the fixed barrel 73. When the flange back adjustment is performed, the flange back knob 76 is loosened and the flange back operation ring 74 is rotated about the optical axis 0. An outer circumferential portion of the flange back operation ring 74 is provided with a gear portion that meshes with a flange back operation member gear 79 fitted to an input shaft 78a of a flange back operation ring detector 78. The flange back operation ring detector 78 detects the movement amount of the flange back operation ring 74 through the flange back operation member gear 79. The processor 63 calculates the movement amount of the imaging movable barrel 40 based on the detected movement amount and transmits the driving information to the actuator 44. The actuator 44 rotates the output shaft 44a based on the driving information. When the output shaft 44a is rotated, the driving ring 42 is rotated through the first gear 45 and the rear-end optical system 39 is driven in the optical axis direction. The movement of the flange back operation ring 74 in the optical axis direction is restricted by an intermediate pressing ring 80 and a flange back operation ring press 81 that are fixed to the fixed barrel 73 with screws or the like not illustrated.

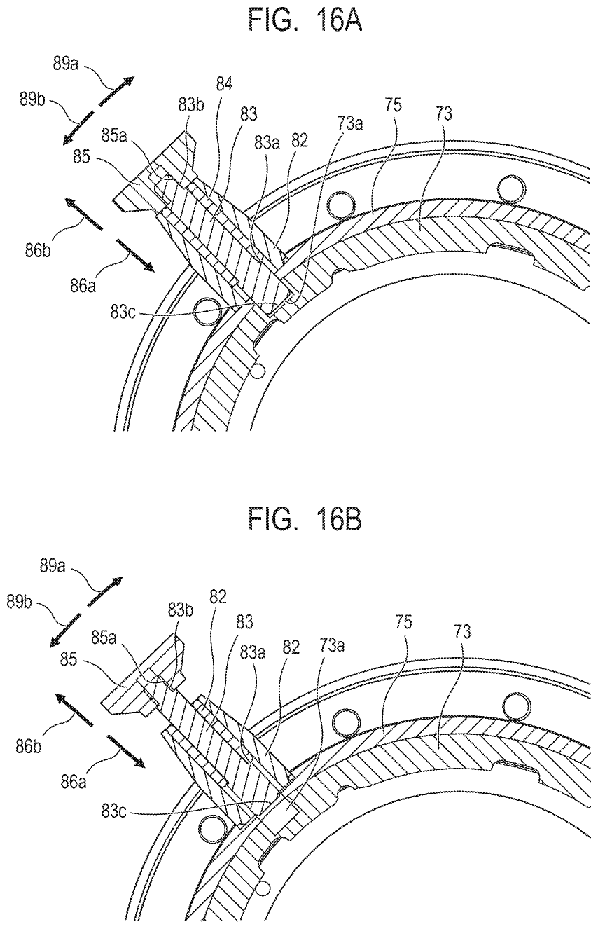

FIG. 16A is a cross-sectional view of a macro operation member in a state where a macro operation ring is fixed as viewed from the image plane side. FIG. 16B is a cross-sectional view of the macro operation member in a state where the macro operation ring is operated as viewed from the image plane side. With reference to FIGS. 16A and 16B, description is given of an operation for macrophotography.

The macro operation ring 75 is in a circular ring shape and includes a through hole 75a fitted to a shaft cover 82. The shaft cover 82 is in a cylindrical shape and houses a shaft 83 and a biasing spring 84 in its inner circumferential portion. The shaft 83 includes a stepped portion 83a that is biased by the biasing spring 84 and a thread portion 83b that threadedly engages with a thread portion 85a provided in the macro knob 85. When the macrophotography is not performed, the shaft 83 is always biased in a direction 86a by the biasing spring 84. An end portion 83c of the shaft 83 is fitted to a fixing hole 73a provided at an outer circumferential portion of the fixed barrel 73, so that the macro operation ring 75 is fixed to the fixed barrel 73. When the macrophotography is performed, the macro knob 85 is moved in a direction 86b to release the end portion 83c of the shaft 83 from the fitting to the fixing hole 73a of the fixed barrel 73. In this state, the macro operation ring 75 is rotated about the optical axis 0. An outer circumferential portion of the macro operation ring 75 is provided with a gear portion that meshes with a macro ring gear 88 fitted to an input shaft 87a of a macro operation ring detector 87, and the macro operation ring detector 87 detects the movement amount of the macro operation ring 75 through the macro ring gear 88.

Based on the detected movement amount, the processor 63 calculates the movement amount of the imaging movable barrel 40 and transmits the driving information to the actuator 44. The actuator 44 rotates the output shaft 44a based on the driving information. When the output shaft 44a is rotated, the driving ring 42 is rotated through the first gear 45 and the rear-end optical system 39 is driven in the optical axis direction. The movement of the macro operation ring 75 in the optical axis direction is restricted by the intermediate pressing ring 80 and a stepped portion 73b included in the macro operation ring 75. When the flange back operation ring 74 and the macro operation ring 75 are moved in an operation direction 89a, the rear-end optical system 39 is moved toward the object side. When the flange back operation ring 74 and the macro operation ring 75 are moved in an operation direction 89b, the rear-end optical system 39 is moved toward the image plane side.

As an effect of Embodiment 3, the structure in which the rear-end optical system operation member 72 is provided in the outer circumferential portion of the fixed barrel 73 makes it possible to make the outer diameter of the imaging unit 6 small.

When an image pickup apparatus is formed of a lens apparatus of the present invention and a camera apparatus including an image pickup element arranged on an image plane of the lens apparatus, it is possible to achieve the image pickup apparatus capable of producing the effect of the present invention. The present invention has been described based on the preferred embodiments. However, the present invention is not limited to these embodiments, but may be modified and altered in various manners within the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-078404, filed Apr. 17, 2019, which is hereby incorporated by reference herein in its entirety.

What is claimed is:

1. A lens apparatus comprising:
a first optical system movable in a direction of an optical axis to change an object distance;
a second optical system arranged closer to an image side than the first optical system, and movable in the direction to adjust a position of an image plane;
a first operation member configured to be operated to move the first optical system;
a driving device configured to drive the second optical system; and
a second operation member configured to be operated to control the driving device, at least a part of the second operation member being arranged closer to an object side in the direction than the second optical system.

2. The lens apparatus according to claim 1, further comprising:
a conversion optical system arranged between the first optical system and the second optical system in the direction and configured to convert a focal length of the lens apparatus by being inserted into or removed from an optical path; and
a housing configured to house the conversion optical system removed from the optical path, wherein
the at least a part of the second operation member is arranged to overlap with the housing in the direction.

3. The lens apparatus according to claim 1, wherein
the second operation member has an operation range along an arc in a circle having the optical axis as a center in a cross-section orthogonal to the optical axis.

4. The lens apparatus according to claim 2, wherein
the second operation member is arranged along a circle having the optical axis as a center in a cross-section orthogonal to the optical axis, and is arranged closer to the object side or closer to the image side in the direction than the conversion optical system.

5. The lens apparatus according to claim 1, further comprising:
a third optical system movable in the direction to change a focal length of the lens apparatus;
an aperture stop mechanism movable to change a light amount;
a conversion optical system configured to convert a focal length of the lens apparatus by being inserted into or removed from an optical path; and
a controller configured to control a position of the second optical system based on at least one of a position of the first optical system, a position of the third optical system, a state of the aperture stop mechanism, and a state of the conversion optical system.

6. The lens apparatus according to claim 1, wherein
at least a flange back adjustment is achieved by moving the second optical system.

7. The lens apparatus according to claim 1, wherein at least a macro operation is achieved by moving the second optical system.

8. An image pickup apparatus comprising:
a lens apparatus; and
an image pickup element configured to pick up an image formed by the lens apparatus,
wherein the lens apparatus comprises:
a first optical system movable in a direction of an optical axis to change an object distance;
a second optical system arranged closer to an image side than the first optical system, and movable in the direction to adjust a position of an image plane;
a first operation member configured to be operated to move the first optical system;
a driving device configured to drive the second optical system; and
a second operation member configured to be operated to control the driving device, at least a part of the second operation member being arranged closer to an object side in the direction than the second optical system.
